(19) United States
(12) Patent Application Publication
(10) Pub. No.: US 2026/0269505 A1
(43) Pub. Date: Sep. 10, 2026

(54) Modular Connection System

(71) Applicant: Aptiv Technologies AG, Schaffhausen (CH)

(72) Inventors: Jeffrey S. Campbell, West Bloomfield, MI (US); Wesley W. Weber, JR., Lapeer, MI (US); Kurt P. Seifert, Cortland, OH (US); Clint Schlosser, Landisville, PA (US); Pradeep Kumar Ashok, Irvine, CA (US)

(21) Appl. No.: 19/465,419

(22) Filed: Jan. 30, 2026

Related U.S. Application Data
(60) Provisional application No. 63/769,334, filed on Mar. 10, 2025.
(60) Provisional application No. 63/798,789, filed on May 2, 2025.

(51) Int. Cl. H01R 13/424; H01R 13/627

(52) U.S. Cl. CPC H01R 13/424; H01R 13/6272

(57) ABSTRACT

A connector includes a housing including a first portion and a second portion. The first portion defines a first cavity that is configured to receive (i) a first terminal module in a first configuration and (ii) a second terminal module in a second configuration. The second portion defines a first aperture in communication with the first cavity. The first aperture is configured to receive a secondary lock to secure (i) the first terminal module in the first cavity in the first configuration and (ii) the second terminal module in the first cavity in the second configuration.

### CROSS-REFERENCE TO RELATED APPLICATIONS

This application claims the benefit of U.S. Provisional Application No. 63/769,334, filed Mar. 10, 2025, the entire disclosure of which is incorporated by reference.

### FIELD

The present disclosure relates to connection systems and, more particularly, to a modular connection system for transferring electricity or data.

### BACKGROUND

Conventional electrical connectors are typically designed as fixed, application-specific assemblies, necessitating custom tooling, extensive prototyping, and high capital expenditures (CAPEX) for each new variant. This results in prolonged development cycles, elevated costs, and limited scalability, particularly for diverse customer requirements in industries such as automotive, aerospace, and consumer electronics.

While known connector systems have proven acceptable for their intended purpose, a continuous need for improvement remains in the pertinent art to address the challenges associated with robust coupling of connectors relative to other connectors and devices.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the present disclosure provides a connector. The connector includes a housing including a first portion and a second portion. The first portion defines a first cavity that is configured to receive (i) a first terminal module in a first configuration and (ii) a second terminal module in a second configuration. The second portion defines a first aperture in communication with the first cavity. The first aperture is configured to receive a secondary lock to secure (i) the first terminal module in the first cavity in the first configuration and (ii) the second terminal module in the first cavity in the second configuration.

Another aspect of the present disclosure provides a terminal module. The terminal module includes an outer peripheral surface surrounding a terminal cavity that defines a cavity geometry. The terminal module is configured to be disposed in (i) a first cavity of a housing in a first configuration and (ii) a second cavity of the housing in a second configuration. The outer peripheral surface defines a first aperture configured to receive a secondary lock to secure the terminal module in (i) the first cavity in the first configuration and (ii) the second cavity in the second configuration.

Another aspect of the present disclosure provides a secondary lock. The secondary lock includes a locking member that is configured to be disposed within an aperture of a connector housing. The aperture is in communication with a cavity of the connector housing. The locking member is configured to secure (i) a first terminal module in the cavity in a first configuration and (ii) a second terminal module in the cavity in a second configuration.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1A is a perspective view of a connector assembly in a first configuration according to the principles of the present disclosure.

FIG. 1B is a perspective view of the connector assembly of FIG. 1A in a second configuration.

FIG. 1C is an exploded view of the connector assembly of FIG. 1A.

FIG. 2A is a perspective view of a connector and terminal modules in a first configuration according to the principles of the present disclosure.

FIG. 2B is a perspective view of the connector and terminal modules of FIG. 2A in a second configuration.

FIG. 3 is a cross-sectional view of the connector of FIG. 2A.

FIG. 4 is a perspective view of another connector according to the principles of the present disclosure.

FIG. 5 is a perspective view of a ground clip of the connector of FIG. 4.

FIG. 6 is a cross-sectional view of the connector of FIG. 4.

FIG. 7 is a perspective view of another connector according to the principles of the present disclosure.

FIG. 8 is another perspective view of the connector of FIG. 7.

FIG. 9 is a perspective view of a secondary lock according to the principles of the present disclosure.

FIG. 10 is a cross-sectional view of the secondary lock of FIG. 9 disposed in a connector.

FIG. 11 is a perspective view of a header according to the principles of the present disclosure.

In the drawings, reference numbers may be reused to identify similar and/or identical elements.

### DETAILED DESCRIPTION

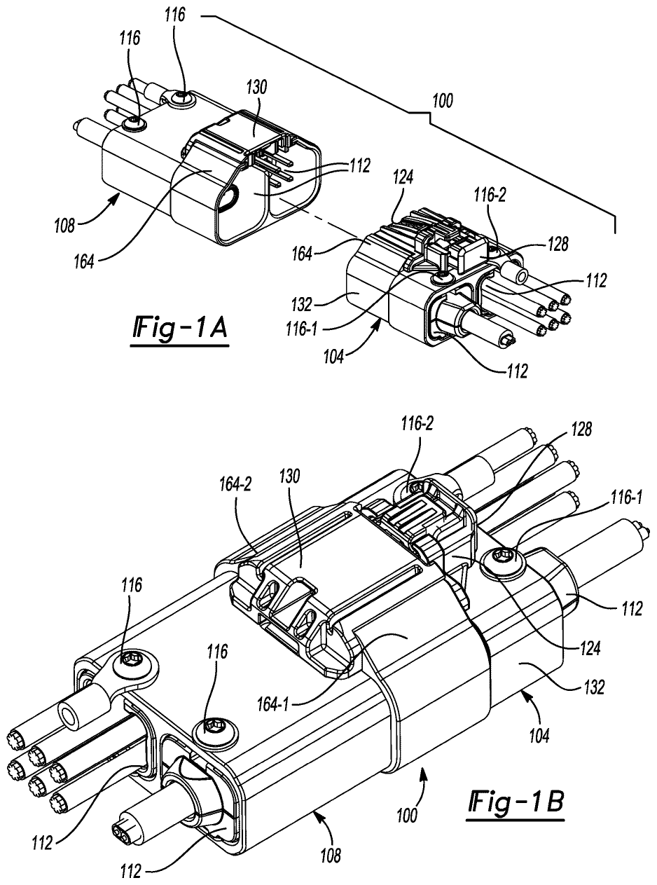

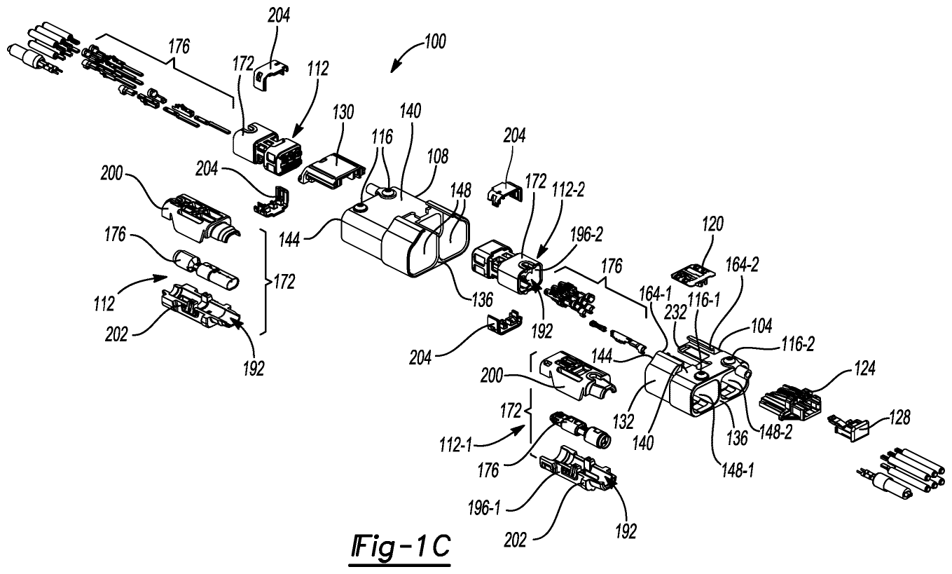

FIGS. 1A, 1B, and 1C illustrate a connector assembly 100. As will be explained in more detail below, the connector assembly 100 may be connected to an electrical system (e.g., an electrical system of a space object, such as a satellite, probe, crewed and uncrewed spacecraft, space stations, etc., or an electrical system of a vehicle, such as an automobile, not shown). The connector assembly 100 may be installed on or within the space object or vehicle. The connector assembly 100 may facilitate transmission of signals, data, and/or electricity between various components of the space object or vehicle.

The connector assembly 100 may include a first connector 104, a second connector 108, a set of terminal modules 112, a set of secondary locks 116, a ground clip 120 (FIG. 4), a modular latch 124, and a connection position assurance (CPA) member 128. The first connector 104 and the second connector 108 may be coupled (e.g., detachably coupled) to one another (FIG. 1B). One or more of the set of terminal modules 112 may be disposed in at least one of the first connector 104 or the second connector 108. In an assembled configuration (FIG. 1B), at least one of the set of terminal modules 112 (e.g., a terminal module disposed in the first connector 104) may engage another one of the set of terminal modules 112 (e.g., a terminal module disposed in the second connector 108) to facilitate transmission of signals, data, and/or electricity therebetween. One or more of the set of secondary locks 116 may be disposed in at least one of the first connector 104 or the second connector 108 to secure one or more of the set of terminal modules 112 in the first connector 104 or the second connector 108. The ground clip 120 may be coupled (e.g., detachably coupled) to one of the first connector 104 or the second connector 108 to ground the first connector 104 and the second connector 108 when they are coupled to one another. The modular latch 124 may be coupled (e.g., detachably coupled) to one of the first connector 104 or the second connector 108 to secure together the first connector 104 and the second connector 108. The CPA member 128 may be coupled to the modular latch 124 to provide additional securement between the first connector 104 and the second connector 108 and proper positioning of the modular latch 124 relative to the first connector 104 or the second connector 108. In various implementations, the connector assembly 100 includes a mating latch 130. The mating latch 130 may be coupled (e.g., detachably coupled) to one of the first connector 104 or the second connector 108, and the modular latch 124 may be coupled (e.g., detachably coupled) to the other of the first connector 104 or the second connector 108, and the modular latch 124 may engage the mating latch 130 to secure together the first connector 104 and the second connector 108.

In various implementations, the modular latch 124 may come in multiple keying options. For example, the modular latch 124 may come in four different keying options. Each keying option may be color coded for operator assistance when mating with the first connector 104 or the second connector 108. Each keying option of the modular latch 124 may be configured to mate with different connectors, such as the first connector 104, the second connector 108, or other connectors. Each keying option of the modular latch 124 may have different features (e.g., on the bottom of the modular latch 124) that allow it to mate with only certain connectors.

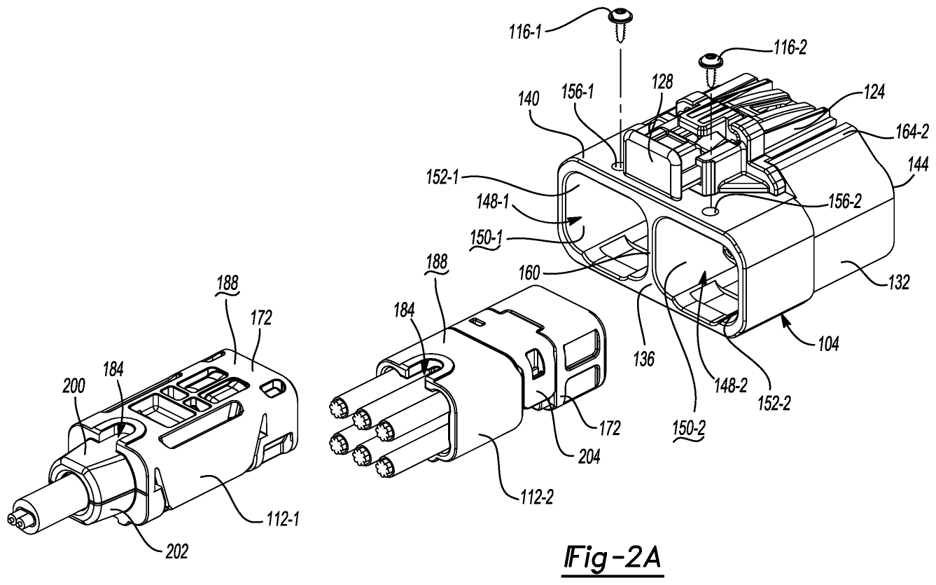

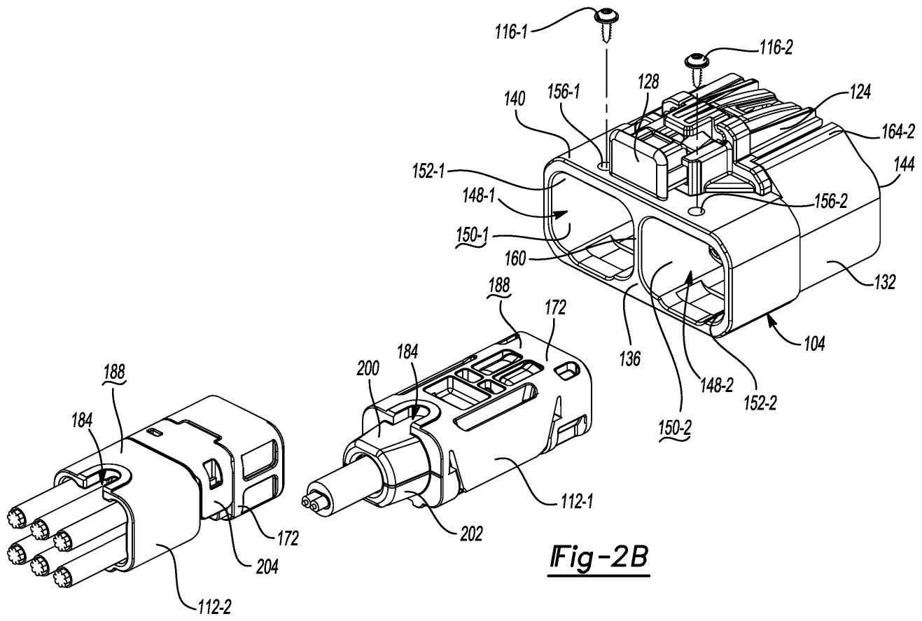

With additional reference to FIGS. 2A and 2B, the first connector 104 may include a housing 132 having a first portion 136 (e.g., a first wall), a second portion 140 (e.g., a second wall), and a third portion 144 (e.g., a third wall). The third portion 144 may be opposite the first portion 136. In various implementations, the third portion 144 is substantially (e.g., ±10 degrees) parallel to the first portion 136. The second portion 140 may extend between the first portion 136 and the third portion 144. In various implementations, the second portion 140 is transverse to the first portion 136 and the third portion 144. In various implementations, the second portion 140 is substantially (e.g., ±10 degrees) perpendicular to the first portion 136 and the third portion 144. In various implementations, the first connector 104 is made of a metal material.

The first portion 136 may define a set of cavities 148. For example, the first portion 136 may define a first cavity 148-1 and a second cavity 148-2. While the first portion 136 is shown and described herein as defining two cavities, it will be appreciated that the first portion 136 may define a single cavity or more than two cavities within the scope of the present disclosure. At least one of the set of cavities may receive one or more of the set of terminal modules 112. In various implementations, the first cavity 148-1 may receive a first terminal module 112-1 in a first configuration (FIG. 2A) and a second terminal module 112-2 in a second configuration (FIG. 2B). In various implementations, the second cavity 148-2 receives the second terminal module 112-2 in the first configuration (FIG. 2A) and the first terminal module 112-1 in the second configuration (FIG. 2B).

Each of the set of cavities 148 may include an inner surface 150 that defines a housing cavity geometry 152. For example, the first cavity 148-1 may include an inner surface 150-1 that defines a first housing cavity geometry 152-1, and the second cavity 148-2 may include an inner surface 150-2 that defines a second housing cavity geometry 152-2. In various implementations, each of the housing cavity geometries is the same as the other housing cavity geometries (e.g., the first housing cavity geometry 152-1 and the second housing cavity geometry 152-2 are identical).

Each of the housing cavity geometries may conform to at least one of the set of terminal modules 112, such that the terminal module fits within the housing cavity with zero or near-zero clearance.

The second portion 140 may define a set of apertures 156. Each of the set of apertures 156 may be in communication (e.g., fluid communication) with one or more of the set of cavities 148. For example, the set of apertures 156 may include a first aperture 156-1 in communication with the first cavity 148-1 and a second aperture 156-2 in communication with the second cavity 148-2. Each of the set of apertures 156 may receive one or more of the set of secondary locks 116, such that the secondary lock extends through the aperture and into the cavity to secure at least one of the set of terminal modules 112 therein.

In various implementations, the first connector 104 includes an intervening wall 160 that extends between and at least partially defines the first cavity 148-1 and the second cavity 148-2.

In various implementations, the first connector 104 includes a set of retention members 164 that extend from the second portion 140. In various implementations, the set of retention members 164 includes a first retention member 164-1 and a second retention member 164-2 extending from opposite sides of the second portion 140. In various implementations, the first retention member 164-1 and the second retention member 164-2 collectively define a slot 168 (FIG. 4). The modular latch 124 may be disposed in the slot 168. The first retention member 164-1 and the second retention member 164-2 may collectively engage the modular latch 124 to secure it within the slot 168.

The second connector 108 may be substantially similar to the first connector 104, such that the description of the first connector 104, or any component thereof, will be understood to apply equally to the second connector 108, or the corresponding component thereof, unless otherwise noted. For example, the second connector 108 may include the first portion 136, the second portion 140, the third portion 144, the set of cavities 148, the housing cavity geometries 152, the set of apertures 156, the intervening wall 160, the set of retention members 164, and the slot 168. In view of the substantial similarity in structure and function of the components associated with the second connector 108 with respect to the first connector 104, like reference numerals are used hereinafter, and in the drawings, to identify like components. In various implementations, the second connector 108 is made of a metal material.

The first connector 104 and the second connector 108 may be coupled (e.g., detachably coupled) to one another (FIG. 1B). In various implementations, one of the first connector 104 or the second connector 108 is at least partially disposed within the other of the first connector 104 or the second connector 108. In various implementations, the first connector 104 and the second connector 108 have the same number of cavities.

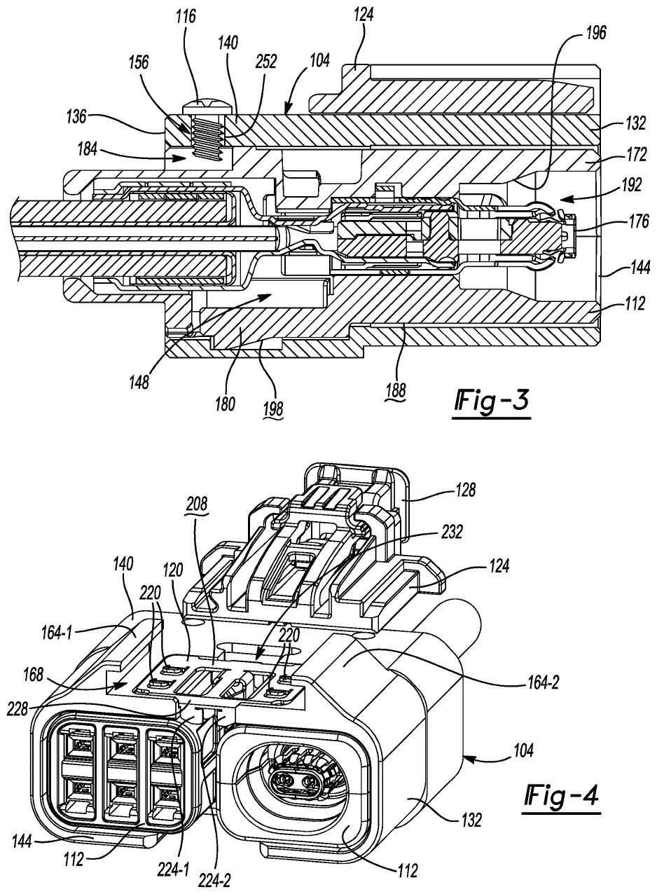

Referring to FIGS. 2A, 2B, and 3, in various implementations, the set of terminal modules 112 includes a first terminal module 112-1 and a second terminal module 112-2. While the set of terminal modules 112 is shown and described herein as having two terminal modules, it will be appreciated that the set of terminal modules 112 may have only a single terminal module or more than two terminal modules within the scope of the present disclosure. In various implementations, the number of terminal modules corresponds to the number of cavities in the first connector 104 and/or the second connector 108. Each of the set of terminal modules 112 may be disposed within at least one of the set of cavities 148. For example, the first terminal module 112-1 may be disposed within the first cavity 148-1 in a first configuration (FIG. 2A) and the second cavity 148-2 in a second configuration (FIG. 2B), and the second terminal module 112-2 may be disposed within the second cavity 148-2 in the first configuration (FIG. 2A) and the first cavity 148-1 in the second configuration (FIG. 2B). In various implementations, each of the set of terminal modules 112 is polarized.

Each of the set of terminal modules 112 may include a terminal housing 172, one or more terminals 176 disposed within the terminal housing 172, a locking mechanism 180 extending from the terminal housing 172, and a recess 184 formed in the terminal housing 172. The terminal housing 172 may include an outer peripheral surface 188 surrounding a terminal cavity 192. In various implementations, the one or more terminals 176 are disposed in the terminal cavity 192. In various implementations, the one or more terminals 176 disposed in the terminal cavity 192 of the first terminal module 112-1 are different from the one or more terminals 176 disposed in the terminal cavity 192 of the second terminal module 112-2.

The outer peripheral surface 188 may define a terminal module geometry 196. In various implementations, the terminal module geometry 196 of each terminal module of the set of terminal modules 112 is the same as the terminal module geometry 196 of every other terminal module of the set of terminal modules 112. For example, the first terminal module 112-1 (e.g., the outer peripheral surface 188) may define a first terminal module geometry 196-1 and the second terminal module 112-2 (e.g., the outer peripheral surface 188) may define a second terminal module geometry 196-2 that is (substantially) the same as the first terminal module geometry 196-1. In various implementations, the terminal module geometry 196 of each of the set of terminal modules 112 conforms (e.g., corresponds) to the housing cavity geometries. In various implementations, the first terminal module geometry 196-1 and the second terminal module geometry 196-2 conform (e.g., correspond) to the first housing cavity geometry 152-1 and the second housing cavity geometry 152-2, such that either of the first terminal module 112-1 or the second terminal module 112-2 fits within the first cavity 148-1 or the second cavity 148-2 with zero or near-zero clearance.

The locking mechanism 180 may extend from the outer peripheral surface 188. The locking mechanism 180 may secure the terminal module within one or more of the set of cavities 148. For example, the locking mechanism 180 of the first terminal module 112-1 may secure the first terminal module 112-1 in the first cavity 148-1 in the first configuration and secure the first terminal module 112-1 in the second cavity 148-2 in the second configuration. As the terminal module is inserted into a cavity of the set of cavities 148, the locking mechanism 180 may flex (e.g., bend) in a first direction (e.g., into the terminal cavity 192) allowing the terminal module to translate (e.g., slide) into the cavity. Once the terminal module is inserted into the cavity, the locking mechanism 180 may flex (e.g., bend) in a second direction (e.g., opposite the first direction) until the locking mechanism 180 engages the cavity (e.g., an interior surface of the cavity). In various implementations, the locking mechanism 180 includes an engagement surface 198 and engagement/disengagement of the engagement surface 198 with the first connector 104 or the second connector 108 causes the locking mechanism 180 to flex. In various implementations, the engagement surface 198 is ramped.

In various implementations, the recess 184 receives one of the set of secondary locks 116 to (further) secure the terminal module within the cavity in which it is disposed. In various implementations, the recess 184 is an aperture (e.g., through-hole) that extends through the outer peripheral surface 188 and into the terminal cavity 192. In various implementations, the recess 184 is aligned with a corresponding aperture of the set of apertures 156 when the terminal module is disposed within the cavity.

In various implementations, the terminal housing 172 includes a first housing member 200 and a second housing member 202. The first housing member 200 may be coupled (e.g., detachably coupled) to the second housing member 202. The first housing member 200 and the second housing member 202 may collectively define the outer peripheral surface 188 and the terminal cavity 192. The locking mechanism 180 may extend from one or the other of the first housing member 200 or the second housing member 202. The recess 184 may be formed in one or the other of the first housing member 200 or the second housing member 202. In various implementations, the locking mechanism 180 and the recess 184 are both disposed/formed on one of the first housing member 200 or the second housing member 202. In various implementations, each of the set of terminal modules 112 includes a secondary locking mechanism 204. The secondary locking mechanism 204 may surround at least one of the first housing member 200 or the second housing member 202 to provide additional securement between the first housing member 200 and the second housing member 202.

In various implementations, each of the set of terminal modules 112 includes creepage features (e.g., various walls, protrusions, and/or recessed surface features) that create a minimum of 2.4 mm surface distance between adjacent terminals and metal housings. The creepage features allow operation of the terminal modules 112 with high voltages and pollution. In various implementations, the creepage features meet IEC60664-1 requirements.

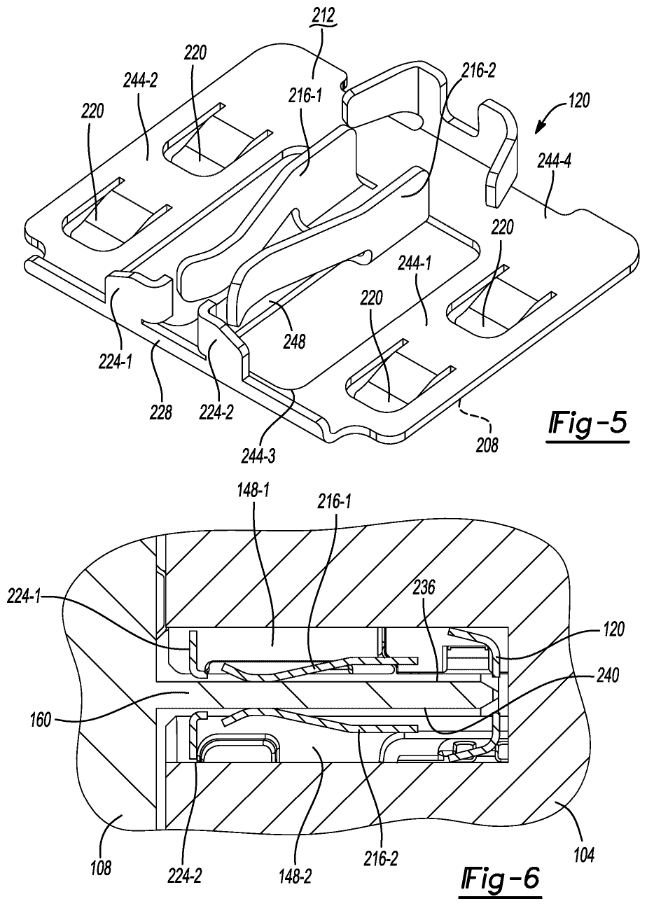

Referring now to FIGS. 4-6, the ground clip 120 includes a top surface 208, a bottom surface 212 opposite the top surface 208, a set of flexible retention members 216, a set of flexible tabs 220, and a set of protrusions 224. The set of flexible retention members 216 may extend from the bottom surface 212. The set of flexible tabs 220 may extend from the top surface 208. The set of protrusions 224 may extend from the bottom surface 212. In various implementations, the set of protrusions 224 extend from a front edge 228 of the bottom surface 212. In various implementations, the first connector 104 includes an opening 232, and the ground clip 120 is disposed within the opening 232. The second connector 108 may additionally or alternatively include the opening 232 within the scope of the present disclosure.

The set of flexible retention members 216 may engage the first connector 104 or the second connector 108 to secure the ground clip 120 to the first connector 104 or the second connector 108. In various implementations, the set of flexible retention members 216 includes a first flexible retention member 216-1 and a second flexible retention member 216-2 spaced apart from and facing the first flexible retention member 216-1. In various implementations, the first flexible retention member 216-1 engages a first side 236 of the intervening wall 160 and the second flexible retention member 216-2 engages a second side 240 of the intervening wall 160. The first flexible retention member 216-1 and the second flexible retention member 216-2 may impart a force on the intervening wall 160 that prevents the ground clip 120 from separating from the first connector 104 or the second connector 108. In an assembled configuration, the first flexible retention member 216-1 may be disposed in the first cavity 148-1 and the second flexible retention member 216-2 may be disposed in the second cavity 148-2.

In an assembled configuration, the set of flexible tabs 220 may engage (i) the first connector 104 or the second connector 108 and (ii) the modular latch 124 on the other of the first connector 104 or the second connector 108. The modular latch 124 may apply a force on the set of flexible tabs 220, and the force may flex (e.g., bend) the set of flexible tabs 220 (e.g., towards the first connector 104 or the second connector 108), which in turn restricts movement between the first connector 104 or the second connector 108 and the modular latch 124. In other words, the set of flexible tabs 220 may reduce or eliminate rattle between the first connector 104 or the second connector 108 and the modular latch 124. In various implementations, the set of flexible tabs 220 includes four flexible tabs.

In various implementations, the set of protrusions 224 protects the set of flexible retention members 216 from damage during mating and/or handling of the first connector 104 and the second connector 108. The set of protrusions 224 may include a first protrusion 224-1 disposed proximate the first cavity 148-1 and a second protrusion 224-2 disposed proximate the second cavity 148-2.

In various implementations, the ground clip 120 includes a set of edge members 244 and a central member 248. For example, the set of edge members 244 may include a first edge member 244-1, a second edge member 244-2 spaced apart from and substantially (±10 degrees) parallel to the first edge member 244-1, a third edge member 244-3 extending substantially (±10 degrees) perpendicular to and connecting the first edge member 244-1 and the second edge member 244-2, and a fourth edge member 244-4 spaced apart from the third edge member 244-3 and extending substantially (±10 degrees) perpendicular to and connecting the first edge member 244-1 and the second edge member 244-2. The central member 248 may be disposed between the first edge member 244-1 and the second edge member 244-2. The central member 248 may extend substantially (±10 degrees) parallel to the first edge member 244-1 and the second edge member 244-2. The central member 248 may connect the third edge member 244-3 and the fourth edge member 244-4. In various implementations, the ground clip 120 provides a ground connection between the first connector 104 and the second connector 108 when they are mated to one another.

In various implementations, the set of secondary locks 116 includes a first secondary lock 116-1 and a second secondary lock 116-2. While the set of secondary locks 116 is shown and described herein as having two secondary locks, it will be appreciated that the set of secondary locks 116 may have only a single secondary lock or more than two secondary locks within the scope of the present disclosure. In various implementations, the number of secondary locks corresponds to the number of cavities in the first connector 104 and/or the second connector 108, or to the number of terminal modules.

Each of the set of secondary locks 116 may be disposed within at least one of the set of apertures 156. For example, the first secondary lock 116-1 may be disposed in the first aperture 156-1 and the second secondary lock 116-2 may be disposed in the second aperture 156-2. Each of the set of secondary locks 116 may extend through the corresponding aperture of the set of apertures 156 into a cavity of the set of cavities 148 to secure a corresponding terminal module of the set of terminal modules 112 within a corresponding cavity of the set of cavities 148. Each of the set of secondary locks may extend into the recess 184 of a corresponding terminal module to secure the terminal module within the cavity. For example, the first secondary lock 116-1 may secure the first terminal module 112-1 in the first cavity 148-1 in a first configuration and secure the second terminal module 112-2 in the first cavity 148-1 in a second configuration. The second secondary lock 116-2 may secure the second terminal module 112-2 in the second cavity 148-2 in the first configuration and secure the first terminal module 112-1 in the second cavity 148-2 in the second configuration.

In various implementations, each of the set of secondary locks 116 includes a locking member 252. In various implementations, the locking member 252 is or includes a fastener, such as a threaded fastener. In various implementations, each of the set of secondary locks 116 provides a ground connection between the first connector 104 or the second connector 108 and the corresponding terminal module of the set of terminal modules 112 to which it is engaged.

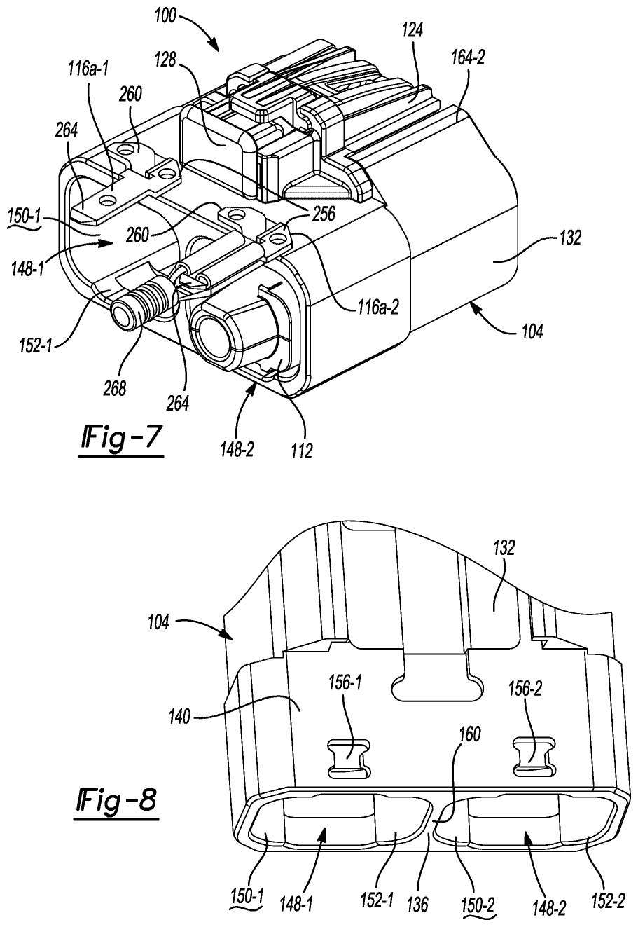

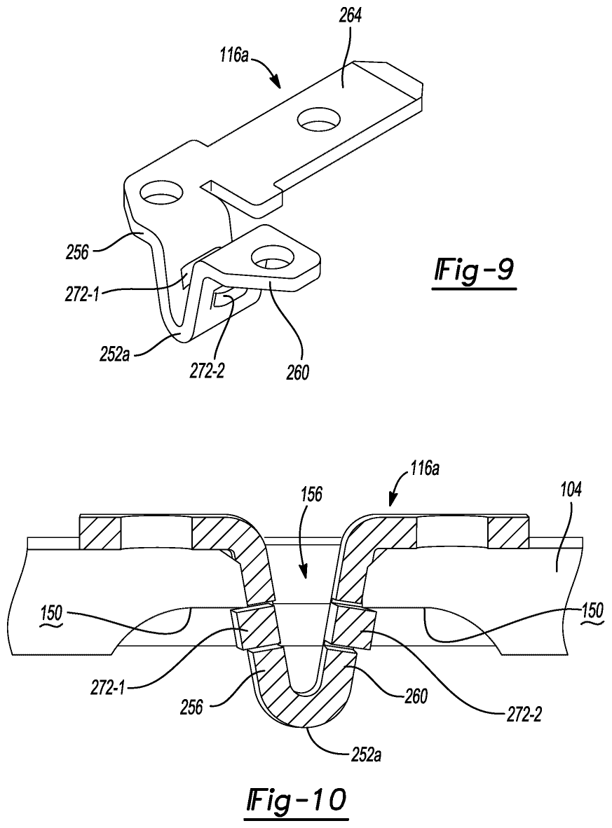

FIGS. 7-10 illustrate another set of secondary locks 116a. As will be explained in more detail below, the set of secondary locks 116a may be used in place of or in addition to the set of secondary locks 116 in the connector assembly 100. In view of the substantial similarity in structure and function of the components associated with the set of secondary locks 116a relative to the set of secondary locks 116, like reference numerals are used hereinafter, and in the drawings, to identify like components while like reference numerals containing letter extensions (e.g., “a”) are used to identify those components that have been modified.

Each of the set of secondary locks 116a may include a locking member 252a having a first body portion 256, a second body portion 260, and a terminal portion 264. The terminal portion 264 may extend from one or the other of the first body portion 256 or the second body portion 260. In various implementations, the terminal portion extends transversely from (e.g., substantially perpendicular to) the first body portion 256 or the second body portion 260. In various implementations, the terminal portion 264 engages (e.g., is disposed in or received by) an external grounding terminal 268. The external grounding terminal 268 may be a part of the connector assembly 100 or a part of the larger electrical system of which the connector assembly is a part.

The first body portion 256 may be coupled (e.g., flexibly coupled) to the second body portion 260. In this regard, at least one of the first body portion 256 or the second body portion 260 may flex (e.g., rotate) relative to the other of the first body portion 256 or the second body portion 260. In various implementations, the at least one of the first body portion 256 or the second body portion 260 flexes (e.g., rotates) towards the other of the first body portion 256 or the second body portion 260. For example, prior to inserting one of the set of secondary locks 116a into one of the set of apertures 156, at least one of the first body portion 256 or the second body portion 260 is flexed (e.g., rotated) towards the other of the first body portion 256 or the second body portion 260, and after inserting the one of the set of secondary locks 116a into the one of the set of apertures 156, at least one of the first body portion 256 or the second body portion 260 is flexed (e.g., rotated) away from the other of the first body portion 256 or the second body portion 260 to secure the one of the set of secondary locks 116a into the one of the set of apertures 156.

In various implementations, each of the set of secondary locks 116a includes a set of retaining clips 272. The set of retaining clips 272 may include a first retaining clip 272-1 extending from the first body portion 256 and a second retaining clip 272-2 extending from the second body portion 260. In various implementations, the first retaining clip 272-1 is integrally formed in the first body portion 256 and the second retaining clip 272-2 is integrally formed in the second body portion 260. In various implementations, the set of retaining clips 272 engages (e.g., contacts) the inner surface 150 to secure one of the set of secondary locks 116a in one of the set of apertures 156.

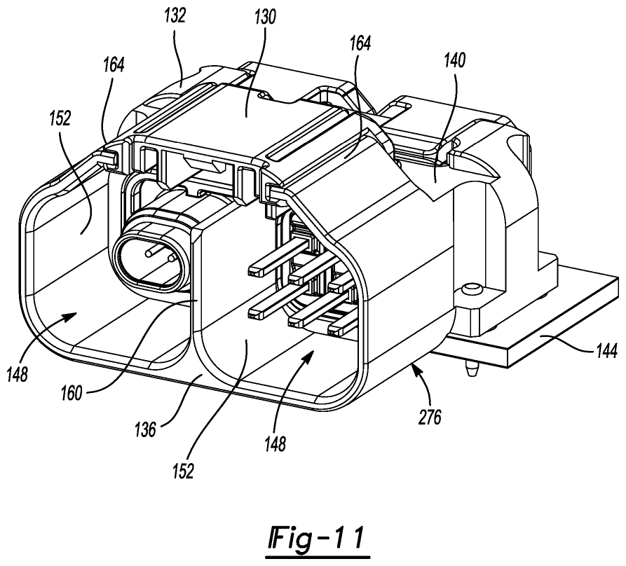

FIG. 11 illustrates a header 276. As will be explained in more detail below, the header 276 may be used in place of or in addition to at least one of the first connector 104 or the second connector 108 in the connector assembly 100. In view of the substantial similarity in structure and function of the components associated with the header 276 relative to the first connector 104 or the second connector 108, like reference numerals are used hereinafter, and in the drawings. The header 276 may include the first portion 136, the second portion 140, the third portion 144, the set of cavities 148, the housing cavity geometries 152, the set of apertures 156 (not shown), the intervening wall 160, the set of retention members 164, and the slot 168. The header 276 may differ from the first connector 104 or the second connector 108 in that the header 276 may be connected to a printed circuit board (PCB, not shown). For example, the third portion 144 may include features that allow the header 276 to connect to a PCB. In various implementations, the third portion 144 of the header 276 may extend perpendicularly to the first portion 136. In this regard, the header may have a right-angle design.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Unless indicated otherwise, numbering or other labeling of instructions or method steps is done for convenient reference, not to indicate a fixed order.

Numerical terms, such as “first,” “second,” and “third,” may be used in the disclosure and claims as unique labels: they are not used to imply a sequence or order unless the context clearly indicates otherwise. In other words, a “second” element could be relabeled as a “first” element without departing from the principles of the present disclosure. Further, the presence of a “second” element does not imply or require the presence of a “first” element. Similarly, the presence of a “first” element does not imply or require the presence of a “second” element.

Unless the context clearly indicates otherwise, the singular articles “a,” “an,” and “the” before a noun do not restrict the noun to a single instance. The verbs “comprise,” “include,” and “have” are inclusive and therefore specify the presence of elements without excluding the presence of one or more additional elements.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements are described using various terms, including “connected,” “coupled,” “engaged,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

The term “set” generally means a grouping of one or more elements. The elements of a set do not necessarily need to have any characteristics in common or otherwise belong together. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase “A, B, and/or C” should be construed in the same way as the phrase “at least one of A, B, and C.”

The examples of the present disclosure may include one or more components such as connectors, terminals, conductors, insulating members, shielding structures, housings, retention features, and sealing elements, among others, as well as corresponding systems and assemblies. These examples may be configured to facilitate electrical signal transmission, power delivery, electromagnetic compatibility, or mechanical retention under various environmental conditions, such as thermal cycling, vibration, or exposure to fluids. Disclosed components, systems, and assemblies, among others, may be arranged modularly or integrally to accommodate various system architectures and routing constraints.

Disclosed components may be fabricated from thermoplastics, thermoset resins, composites, or metals, optionally treated or coated for corrosion resistance, electromagnetic interference shielding, or biocompatibility for use in various applications, systems, and environments, among others. In particular, in medical applications, sterilizable and/or biocompatible materials may be used. In solar or renewable energy systems, UV-resistant and/or weatherproof materials may be incorporated. In aerospace and space-based systems, weight reduction may be prioritized, and high-performance materials such as polyimide films, fluoropolymers, or ceramic composites may be employed.

Disclosed components, systems, and assemblies, among others, may be designed for automated assembly, including robotic insertion, ultrasonic welding, or crimping techniques. Adaptations may be made to ensure compliance with relevant standards, including International Organization for Standardization, Military Specification, Society of Automotive Engineers, Food and Drug Administration, or International Electrotechnical Commission, depending on the target industry or market. In this regard, while examples and embodiments of the present disclosure may be illustrated and described herein in the context of an automobile, it will be appreciated that such examples and embodiments are equally suited for other applications, systems, environments, industries, and markets, among others. For example, implementations of the present disclosure that relate generally to electrical components and assemblies, and more particularly to connectors, terminals, wiring harnesses, and integrated electrical interconnection systems, among others, are suitable for a wide range of environments and applications.

While exemplary embodiments described herein may reference automotive use cases, the disclosed technology is not limited thereto and may be employed in any system requiring, for example, robust, secure, reliable, and/or durable electrical connectivity, among others. In particular, the structures, materials, and configurations disclosed may be adapted for use in aerospace systems, medical devices, consumer electronics, industrial automation, energy distribution networks, solar and other renewable energy installations, marine vessels, and space exploration platforms. Accordingly, although specific embodiments may describe automotive implementations, the principles disclosed herein are equally applicable to any system requiring robust electrical interconnection, and claims directed to any system, application, and/or environmental domain are, and will be, contemplated by one of skill in the art.

Various example embodiments of the invention are described in the following clauses.

Clause 1: A connector comprising: a housing including a first portion and a second portion, the first portion defining a first cavity, the first cavity configured to receive (i) a first terminal module in a first configuration and (ii) a second terminal module in a second configuration; and the second portion defining a first aperture in communication with the first cavity and configured to receive a secondary lock to secure (i) the first terminal module in the first cavity in the first configuration and (ii) the second terminal module in the first cavity in the second configuration.

Clause 2: The connector of clause 1 wherein: the first portion defines a second cavity configured to receive (i) the second terminal module in the first configuration and (ii) the first terminal module in the second configuration, and the second portion defines a second aperture in communication with the second cavity and configured to receive an additional secondary lock to secure (i) the second terminal module in the second cavity in the first configuration and (ii) the first terminal module in the second cavity in the second configuration.

Clause 3: The connector of clause 2 wherein: the first cavity defines a first housing cavity geometry, the first terminal module includes a first outer peripheral surface defining a first terminal module geometry and surrounding a first terminal cavity defining a first terminal cavity geometry, and the first terminal module geometry conforms to the first housing cavity geometry.

Clause 4: The connector of clause 3 wherein: the second terminal module includes a second outer peripheral surface defining a second terminal module geometry and surrounding a second terminal cavity defining a second terminal cavity geometry that is different than the first terminal cavity geometry, and the second terminal module geometry conforms to the first housing cavity geometry.

Clause 5: The connector of any of clauses 3-4 wherein the first terminal module includes a locking mechanism extending from the first outer peripheral surface and configured to secure (i) the first terminal module in the first cavity in the first configuration and (ii) the first terminal module in the second cavity in the second configuration.

Clause 6: A connector assembly comprising: the connector of any of clauses 1-5; and the secondary lock configured to be disposed within the first aperture to secure (i) the first terminal module in the first cavity in the first configuration and (ii) the second terminal module in the first cavity in the second configuration.

Clause 7: The connector assembly of clause 6 further comprising an additional secondary lock, wherein: the housing defines a second cavity and a second aperture in communication with the second cavity, and the additional secondary lock is configured to be disposed within the second aperture to secure (i) the second terminal module within the second cavity in the first configuration and (ii) the first terminal module in the second cavity in the second configuration.

Clause 8: The connector assembly of any of clauses 6-7 further comprising a grounding clip, wherein: the housing defines an opening configured to receive the grounding clip, and the grounding clip is configured to ground the housing and a mating connector housing when the housing is coupled to the mating connector housing.

Clause 9: The connector assembly of clause 8 wherein: the housing defines a second cavity, the housing includes a wall extending between the first cavity and the second cavity, the grounding clip includes (i) a first flexible retention member configured to engage a first side of the wall facing the first cavity and (ii) a second flexible retention member configured to engage a second side of the wall facing the second cavity, and the first flexible retention member and the second flexible retention member are configured to secure the grounding clip to the housing.

Clause 10: The connector assembly of clause 9 wherein the grounding clip includes: a set of protrusions configured to shield the first flexible retention member or the second flexible retention member when the housing is coupled to the mating connector housing, and a set of flexible tabs configured to restrict movement between the housing and the grounding clip.

Clause 11: A terminal module comprising: an outer peripheral surface surrounding a terminal cavity defining a cavity geometry, the terminal module configured to be disposed in (i) a first cavity of a housing in a first configuration and (ii) a second cavity of the housing in a second configuration; and the outer peripheral surface defining a first aperture configured to receive a secondary lock to secure the terminal module in (i) the first cavity in the first configuration and (ii) the second cavity in the second configuration.

Clause 12: The terminal module of clause 11 further comprising a locking mechanism extending from the outer peripheral surface and configured to secure (i) the terminal module in the first cavity in the first configuration and (ii) the terminal module in the second cavity in the second configuration.

Clause 13: The terminal module of any of clauses 11-12 wherein: the terminal module defines a first aperture in the outer peripheral surface, and the first aperture is configured to receive (i) a first secondary lock to secure the terminal module in the first cavity in the first configuration and (ii) a second secondary lock to secure the terminal module in the second cavity in the second configuration.

Clause 14: The terminal module of any of clauses 11-13 further comprising a set of terminals configured to be disposed in the terminal cavity.

Clause 15: The terminal module of any of clauses 11-14 wherein the terminal module includes: a first housing member, and a second housing member configured to be detachably coupled to the first housing member.

Clause 16: A secondary lock comprising: a locking member configured to be disposed within an aperture of a connector housing, the aperture being in communication with a cavity of the connector housing, the locking member configured to secure (i) a first terminal module in the cavity in a first configuration and (ii) a second terminal module in the cavity in a second configuration.

Clause 17: The secondary lock of clause 16 wherein: the locking member includes a first body portion and a second body portion flexibly coupled to the first body portion, and at least one of the first body portion or the second body portion is configured to flex relative to the other of the first body portion or the second body portion to secure the secondary lock in the aperture.

Clause 18: The secondary lock of clause 17 wherein: the locking member includes a terminal portion extending from at least one of the first body portion or the second body portion, and the terminal portion is configured to engage an external grounding terminal.

Clause 19: The secondary lock of any of clauses 16-18 wherein the locking member is configured to provide grounding between (i) the first terminal module and the connector housing in the first configuration and (ii) the second terminal module and the connector housing in the second configuration.

Clause 20: The secondary lock of any of clauses 16-19 wherein the locking member includes a threaded fastener.

1. A connector comprising:
a housing including a first portion and a second portion, the first portion defining a first cavity, the first cavity configured to receive (i) a first terminal module in a first configuration and (ii) a second terminal module in a second configuration; and
the second portion defining a first aperture in communication with the first cavity and configured to receive a secondary lock to secure (i) the first terminal module in the first cavity in the first configuration and (ii) the second terminal module in the first cavity in the second configuration.

2. The connector of claim 1 wherein:
the first portion defines a second cavity configured to receive (i) the second terminal module in the first configuration and (ii) the first terminal module in the second configuration, and
the second portion defines a second aperture in communication with the second cavity and configured to receive an additional secondary lock to secure (i) the second terminal module in the second cavity in the first configuration and (ii) the first terminal module in the second cavity in the second configuration.

3. The connector of claim 2 wherein:
the first cavity defines a first housing cavity geometry,
the first terminal module includes a first outer peripheral surface defining a first terminal module geometry and surrounding a first terminal cavity defining a first terminal cavity geometry, and
the first terminal module geometry conforms to the first housing cavity geometry.

4. The connector of claim 3 wherein:
the second terminal module includes a second outer peripheral surface defining a second terminal module geometry and surrounding a second terminal cavity defining a second terminal cavity geometry that is different than the first terminal cavity geometry, and
the second terminal module geometry conforms to the first housing cavity geometry.

5. The connector of claim 3 wherein the first terminal module includes a locking mechanism extending from the first outer peripheral surface and configured to secure (i) the first terminal module in the first cavity in the first configuration and (ii) the first terminal module in the second cavity in the second configuration.

6. A connector assembly comprising:
the connector of claim 1; and
the secondary lock configured to be disposed within the first aperture to secure (i) the first terminal module in the first cavity in the first configuration and (ii) the second terminal module in the first cavity in the second configuration.

7. The connector assembly of claim 6 further comprising an additional secondary lock, wherein:
the housing defines a second cavity and a second aperture in communication with the second cavity, and
the additional secondary lock is configured to be disposed within the second aperture to secure (i) the second terminal module within the second cavity in the first configuration and (ii) the first terminal module in the second cavity in the second configuration.

8. The connector assembly of claim 6 further comprising a grounding clip, wherein:
the housing defines an opening configured to receive the grounding clip, and
the grounding clip is configured to ground the housing and a mating connector housing when the housing is coupled to the mating connector housing.

9. The connector assembly of claim 8 wherein:
the housing defines a second cavity,
the housing includes a wall extending between the first cavity and the second cavity,
the grounding clip includes (i) a first flexible retention member configured to engage a first side of the wall facing the first cavity and (ii) a second flexible retention member configured to engage a second side of the wall facing the second cavity, and
the first flexible retention member and the second flexible retention member are configured to secure the grounding clip to the housing.

10. The connector assembly of claim 9 wherein the grounding clip includes:
a set of protrusions configured to shield the first flexible retention member or the second flexible retention member when the housing is coupled to the mating connector housing, and
a set of flexible tabs configured to restrict movement between the housing and the grounding clip.

11. A terminal module comprising:
an outer peripheral surface surrounding a terminal cavity defining a cavity geometry, the terminal module configured to be disposed in (i) a first cavity of a housing in a first configuration and (ii) a second cavity of the housing in a second configuration; and
the outer peripheral surface defining a first aperture configured to receive a secondary lock to secure the terminal module in (i) the first cavity in the first configuration and (ii) the second cavity in the second configuration.

12. The terminal module of claim 11 further comprising a locking mechanism extending from the outer peripheral surface and configured to secure (i) the terminal module in the first cavity in the first configuration and (ii) the terminal module in the second cavity in the second configuration.

13. The terminal module of claim 11 wherein:
the terminal module defines a first aperture in the outer peripheral surface, and
the first aperture is configured to receive (i) a first secondary lock to secure the terminal module in the first cavity in the first configuration and (ii) a second secondary lock to secure the terminal module in the second cavity in the second configuration.

14. The terminal module of claim 11 further comprising a set of terminals configured to be disposed in the terminal cavity.

15. The terminal module of claim 11 wherein the terminal module includes:
a first housing member, and
a second housing member configured to be detachably coupled to the first housing member.

16. A secondary lock comprising:
a locking member configured to be disposed within an aperture of a connector housing, the aperture being in communication with a cavity of the connector housing, the locking member configured to secure (i) a first terminal module in the cavity in a first configuration and (ii) a second terminal module in the cavity in a second configuration.

17. The secondary lock of claim 16 wherein:
the locking member includes a first body portion and a second body portion flexibly coupled to the first body portion, and
at least one of the first body portion or the second body portion is configured to flex relative to the other of the first body portion or the second body portion to secure the secondary lock in the aperture.

18. The secondary lock of claim 17 wherein:
the locking member includes a terminal portion extending from at least one of the first body portion or the second body portion, and
the terminal portion is configured to engage an external grounding terminal.

19. The secondary lock of claim 16 wherein the locking member is configured to provide grounding between (i) the first terminal module and the connector housing in the first configuration and (ii) the second terminal module and the connector housing in the second configuration.

20. The secondary lock of claim 16 wherein the locking member includes a threaded fastener.
